(19) United States
(12) Patent Application Publication
(10) Pub. No.: US 2026/0302351 A1
(43) Pub. Date: Oct. 1, 2026

(54) NON-AQUEOUS ELECTROLYTE SOLUTION AND POWER STORAGE DEVICE COMPRISING SAME

(71) Applicant: HUECHEMBRAIN CO., LTD, Daejeon (KR)

(72) Inventor: Sei Ung Park, Daejeon (KR)

(21) Appl. No.: 19/480,344

(22) PCT Filed: May 30, 2024
(86) PCT No.: PCT/KR2024/007398

§ 371 Date: Oct. 30, 2025

(30) Foreign Application Priority Data
May 31, 2023 (KR) 10-2023-0069851

(51) Int. Cl. H01M 10/0567; H01M 10/0525; H01M 10/0569

(52) U.S. Cl. CPC H01M 10/0567; H01M 10/0525; H01M 10/0569; H01M 2300/0037

(57) ABSTRACT

The present invention relates to a non-aqueous electrolyte solution and a power storage device comprising same, the non-aqueous electrolyte solution being capable of simultaneously implementing excellent ion conductivity and electrochemical stability by including an additive having a specific structure. A lithium secondary battery employing the non-aqueous electrolyte solution, according to the present invention, can implement excellent output performance and has both improved lifespan characteristics and high-temperature stability.

### TECHNICAL FIELD

The present disclosure relates to a non-aqueous electrolyte solution containing an additive having a specific structure, and a power storage device including the same.

### BACKGROUND ART

Since the characteristics of a lithium secondary battery are exhibited by complex reactions between a positive electrode and an electrolyte and between a negative electrode and an electrolyte, the use of the electrolyte is one of the important factors for improving the performance of the lithium secondary battery.

In recent years, as both miniaturization and an increase in capacity of lithium secondary batteries have been simultaneously required, the required performance of electrolytes applied thereto has been increasingly advanced. Accordingly, research on organic electrolyte solutions having high ionic conductivity and high dielectric constant, and being capable of easily achieving high voltage resistance and miniaturization, has been actively conducted. However, the organic electrolyte solution may cause side reactions between an electrode and an electrolyte, resulting in deterioration of the lifespan characteristics of the lithium secondary battery, and may have large changes in physical properties depending on temperature variation, thereby causing degradation in battery performance under a low-temperature or high-temperature environment.

As a measure to solve these problems, there is a demand for the development of an additive capable of suppressing side reactions with an electrode and maintaining stability even with temperature variation. However, in the case of additives for non-aqueous electrolyte solutions developed to date, although the stability is improved, there are limitations in ionic that conductivity and output characteristics are deteriorated, and when a high-capacity layered positive electrode material having a high nickel content is used, or when lithium metal is used as a negative electrode material, there is a limit to the improvement in stability.

### DISCLOSURE

### Technical Problem

An object of the present invention is to provide a non-aqueous electrolyte solution capable of simultaneously achieving excellent ionic conductivity and electrochemical stability, and a power storage device including the same.

### Technical Solution

In one general aspect, a non-aqueous electrolyte solution contains: a non-aqueous organic solvent; an electrolyte salt; and one or two or more additives selected from compounds represented by the following Chemical Formula 1:

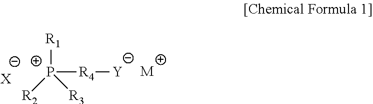

R₁ to R₃ are each independently hydrogen, halogen, (C1-C10)alkyl, (C2-C10) alkenyl, (C2-C10) alkynyl, (C3-C12) cycloalkyl, (C2-C12) heterocycloalkyl, (C6-C12) aryl, (C2-C12) heteroaryl, (C1-C10) alkoxy, (C6-C12) aryloxy, (C2-C10) alkenyloxy, (C2-C10) alkynyloxy, or (C1-C10)alkyl carbonate;
the alkyl, alkenyl, alkynyl, cycloalkyl, heterocycloalkyl, aryl, heteroaryl, alkoxy, aryloxy, alkenyloxy, alkynyloxy, and alkyl carbonate of R₁ to R₃ may each contain one or more halogen atoms;
R₄ may be (C1-C10) alkylene, (C2-C10) alkenylene, (C2-C10) alkynylene, (C3-C12) cycloalkylene, (C2-C12) heterocycloalkylene, (C6-C12) arylene, (C2-C12) heteroarylene, (C1-C10) alkyleneoxy, (C2-C10) alkenyleneoxy, (C2-C10) alkynyleneoxy, (C3-C12) cycloalkyleneoxy, (C6-C12) aryleneoxy, (C2-C12) heteroaryleneoxy, or a combination thereof;
Y⁻ is *—SO₃⁻, *—OSO₃⁻, *—OPO₃H⁻, *—CO₂⁻, or *—OCO₂⁻;
M⁺ is an alkali metal ion, ammonium (NH₄⁺), nitrosyl (NO⁺), triethylamine (Et₃N⁺), diazonium (N₂H₅⁺), hydronium (H₃O⁺), phosphonium (PH₄⁺), diphosphonium (P₂H₅⁺), silylium (SiH₃⁺), or pyridinium; and
X⁻ is a halide ion, cyanide (CN⁻), thiocyanate (SCN⁻), cyanate (OCN⁻), acetate (CH₃COO⁻), nitrate (NO₃⁻), nitrite (NO₂⁻), azide (N₃⁻), tetrafluoroborate (BF₄⁻), hexafluorophosphate (PF₆⁻), trifluoromethanesulfonate (CF₃SO₃⁻), tetrafluorozirconate (ZrF₄⁻), tetrafluoroaluminate (AlF₄⁻), difluorophosphate (PO₂F₂⁻), bis(fluorosulfonyl)imide (FSI⁻), or bis(trifluoromethanesulfonyl)imide (TFSI⁻).

The compound represented by Chemical Formula 1 may be represented by the following Chemical Formula 2.

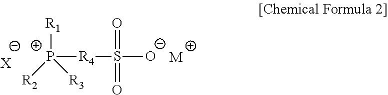

(In Chemical Formula 2, R₁ to R₄, M⁺, and X⁻ are the same as defined in Chemical Formula 1.)

The compound represented by Chemical Formula 1 may be represented by the following Chemical Formula 3.

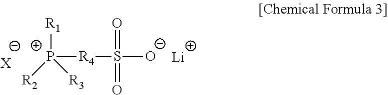

(In Chemical Formula 3, R₁ to R₄ and X⁻ are the same as defined in Chemical Formula 1.)

R₁ to R₃ may each independently be (C6-C12) aryl, (C6-C12) aryloxy, or (C2-C12) heteroaryl; R₄ may be (C1-C4) alkylene or (C2-C4)alkenylene; and X⁻ may be F—, nitrate (NO₃⁻), tetrafluoroborate (BF₄⁻), hexafluorophosphate (PF₆⁻), trifluoromethanesulfonate (CF₃SO₃⁻), tetrafluorozirconate (ZrF₄⁻), tetrafluoroaluminate (ALF₄⁻), difluorophosphate (PO₂F₂—), bis(fluorosulfonyl)imide (FSI⁻), or bis(trifluoromethanesulfonyl)imide (TFSI⁻).

The additive may be contained in an amount of 0.001 to 10 mass % based on the total weight of the non-aqueous electrolyte solution.

The non-aqueous organic solvent may be one or two or more selected from a linear carbonate-based solvent, a cyclic carbonate-based solvent, a linear ester-based solvent, a cyclic ester-based solvent, an ether-based solvent, a ketone-based solvent, an alcohol-based solvent, and an aprotic solvent.

The non-aqueous organic solvent may be a combination of a linear carbonate-based solvent and a cyclic carbonate-based solvent.

The electrolyte salt may be a lithium salt.

In one embodiment, the non-aqueous electrolyte solution may further contain one or two or more auxiliary additives selected from a fluorine-containing cyclic carbonate-based compound, a vinyl group-containing cyclic carbonate-based compound, a vinylene carbonate-based compound, a cyclic sulfate-based compound, a sultone-based compound, a fluorine-containing lithium phosphate-based compound, a lithium borate-based compound, a lactone-based compound, and a sulfonylimide-based compound.

The auxiliary additive may be contained in an amount of 0.01 to 10 wt % based on the total weight of the non-aqueous electrolyte solution.

In another general aspect, a power storage device includes: a positive electrode; a negative electrode; and the non-aqueous electrolyte solution described above.

An active material of the positive electrode may include a composite metal oxide of lithium including one or two or more selected from cobalt, manganese, and nickel; or a lithium-containing olivine-type phosphate containing one or two or more selected from iron, cobalt, nickel, and manganese.

An active material of the negative electrode may include one or two or more selected from a carbon material, tin, a tin compound, silicon, a silicon compound, and lithium titanate.

An active material of the negative electrode may include lithium metal.

The power storage device may be a lithium secondary battery.

In still another general aspect, there is provided a compound represented by the following Chemical Formula 1.

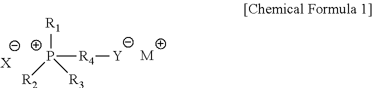

(In Chemical Formula 1, R₁ to R₄, Y⁻, M⁺, and X⁻ are the same as defined in Chemical Formula 1.)

### Advantageous Effects

A lithium secondary battery employing the non-aqueous electrolyte solution according to the present invention may simultaneously improve lifespan characteristics and high-temperature stability while exhibiting excellent output performance.

Specifically, the additive contained in the non-aqueous electrolyte solution according to one embodiment may have a structural feature exhibiting high ionic conductivity and solubility, thereby maximizing battery performance. In addition, the additive may serve to remove hydrofluoric acid and moisture present in the electrolyte solution by itself, may effectively suppress side reactions between the battery and the electrolyte solution, and may form a solid electrolyte interface (SEI) film on the surfaces of the negative electrode and the positive electrode, thereby suppressing decomposition of an organic solvent occurring at a specific voltage and significantly improving battery lifespan and stability. Particularly, the additive may provide excellent stability even for a high-capacity layered positive electrode material having a high nickel content.

In addition, the non-aqueous electrolyte solution according to one embodiment may suppress formation of dendrites on a surface of lithium metal when a lithium metal negative electrode is employed as a next-generation battery, thereby improving stability.

### DESCRIPTION OF DRAWINGS

FIG. 1 is a cross-sectional view schematically illustrating a lithium secondary battery according to one embodiment.

FIGS. 2 to 7 show the infrared spectroscopic analysis (FT-IR) results of compounds (Chemical Formulas 5 to 20) according to Examples 1 to 15.

### BEST MODE

Unless otherwise defined in the present specification, all the technical terms and scientific terms have the same meanings as commonly understood by those skilled in the art to which the present invention pertains. The terms used in the description of the present specification are merely used to effectively describe a specific embodiment, but are not intended to limit the present invention.

Unless the context clearly indicates otherwise, singular forms used in the present specification may be intended to include plural forms.

In addition, a numerical range used in the present specification includes upper and lower limits and all values within these limits, increments logically derived from a form and span of a defined range, all doubly limited values, and all possible combinations of the upper and lower limits in the numerical range defined in different forms. Unless otherwise specifically defined in the present specification, values out of the numerical range that may occur due to experimental errors or rounded values also fall within the defined numerical range.

The expression “comprise(s)” as used in the present specification is intended to be an open-ended transitional phrase an equivalent meaning to “include(s)”, “contain(s)”, “have (has)”, and “are (is) characterized by”, and does not exclude elements, materials, or steps, all of which are not further recited herein.

One embodiment of the present invention provides a non-aqueous electrolyte solution that may simultaneously achieve excellent ionic conductivity and electrochemical stability by containing a compound having a specific structure as an additive.

Specifically, a non-aqueous electrolyte solution according to one embodiment may contain: non-aqueous organic solvent; an electrolyte salt; and one or two or more additives selected from compounds represented by the following Chemical Formula 1.

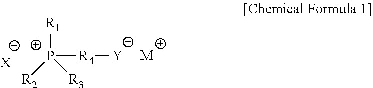

(In Chemical Formula 1,
R₁ to R₃ are each independently hydrogen, halogen, (C1-C10)alkyl, (C2-C10) alkenyl, (C2-C12) alkynyl, (C3-C12) cycloalkyl, (C2-C12) heterocycloalkyl, (C6-C12) aryl, (C2-C12) heteroaryl, (C1-C10) alkoxy, (C6-C12) aryloxy, (C2-C10) alkenyloxy, (C2-C10) alkynyloxy, or (C1-C10)alkyl carbonate;
the alkyl, alkenyl, alkynyl, cycloalkyl, heterocycloalkyl, aryl, heteroaryl, alkoxy, aryloxy, alkenyloxy, alkynyloxy, and alkyl carbonate of R₁ to R₃ may each contain one or more halogen atoms;
R₄ may be (C1-C10) alkylene, (C2-C10) alkenylene, (C2-C10) alkynylene, (C3-C12) cycloalkylene, (C2-C12) heterocycloalkylene, (C6-C12) arylene, (C2-C12) heteroarylene, (C1-C10) alkyleneoxy, (C2-C10) alkenyleneoxy, (C2-C10) alkynyleneoxy, (C3-C12) cycloalkyleneoxy, (C6-C12) aryleneoxy, (C2-C12) heteroaryleneoxy, or a combination thereof;
Y⁻ is *—SO₃⁻, *—OSO₃⁻, *—OPO₃H⁻, *—CO₂⁻, or *—OCO₂⁻;
M⁺ is an alkali metal ion, ammonium (NH₄⁺), nitrosyl (NO⁺), triethylamine (Et₃N⁺), diazonium (N₂H₅⁺), hydronium (H₃₀⁺), phosphonium (PH₄⁺), diphosphonium (P₂H₅⁺), silylium (SiH₃⁺), or pyridinium; and
X⁻ is a halide ion, cyanide (CN⁻), thiocyanate (SCN⁻), cyanate (OCN⁻), acetate (CH₃COO⁻), nitrate (NO₃⁻), nitrite (NO₂), azide (N₃⁻), tetrafluoroborate (BF₄⁻), hexafluorophosphate (PF₆), trifluoromethanesulfonate (CF₃SO₃⁻), tetrafluorozirconate (ZrF₄⁻), tetrafluoroaluminate (AlF₄⁻), difluorophosphate (PO₂F₂), bis(fluorosulfonyl)imide (FSI⁻), or bis(trifluoromethanesulfonyl)imide (TFSI⁻).

The non-aqueous electrolyte solution according to one embodiment may achieve excellent ionic conductivity and solubility due to the above-described structural feature, for example, by having both a cationic portion and an anionic portion in a compound and by introducing ionic functional groups into the cationic portion and the anionic portion of the compound, and the non-aqueous electrolyte solution may also serve to remove hydrofluoric acid and moisture present in the electrolyte solution by itself, and may effectively suppress side reactions between the battery and the electrolyte solution, thereby improving stability.

Here, the alkali metal ion may refer to Li⁺, Na⁺, or K⁺, and the halide ion may refer to F⁻, Cl⁻, Br⁻, or I⁻.

For example, in Chemical Formula 1, R₁ to R₃ may each independently be hydrogen, halogen, (C1-C7)alkyl, (C2-C7) alkenyl, (C2-C7)alkynyl, (C3-C12) cycloalkyl, (C2-C12) heterocycloalkyl, (C6-C12) aryl, (C2-C12) heteroaryl, (C1-C7)alkoxy, (C6-C12) aryloxy, (C2-C7)alkenyloxy, (C2-C7) alkynyloxy, or (C1-C7)alkyl carbonate; and R₄ may be (C1-C7)alkylene, (C2-C7)alkenylene, (C2-C7)alkynylene, (C3-C12) cycloalkylene, (C2-C12) heterocycloalkylene, (C6-C12) arylene, (C2-C12) heteroarylene, (C1-C7)alkyleneoxy, (C2-C7)alkenyleneoxy, (C2-C7)alkynyleneoxy, (C3-C12) cycloalkyleneoxy, (C6-C12) aryleneoxy, (C2-C12) heteroaryleneoxy, or a combination thereof.

For example, in Chemical Formula 1, R₁ to R₃ may each independently be hydrogen, halogen, (C1-C4)alkyl, (C2-C4) alkenyl, (C2-C4)alkynyl, (C3-C12) cycloalkyl, (C2-C12) heterocycloalkyl, (C6-C12) aryl, (C2-C12) heteroaryl, (C1-C4)alkoxy, (C6-C12) aryloxy, (C2-C4)alkenyloxy, (C2-C4) alkynyloxy, or (C1-C4)alkyl carbonate; and R₄ may be (C1-C4)alkylene, (C2-C4)alkenylene, (C2-C4)alkynylene, (C3-C12) cycloalkylene, (C2-C12) heterocycloalkylene, (C6-C12) arylene, (C2-C12) heteroarylene, (C1-C4)alkyleneoxy, (C2-C4)alkenyleneoxy, (C2-C4) (C3-C12) alkynyleneoxy, cycloalkyleneoxy, (C6-C12) aryleneoxy, (C2-C12) heteroaryleneoxy, or a combination thereof.

For example, in Chemical Formula 1, R₁ to R₃ may be the same as or different from each other and may be (C6-12) aryl or (C6-C12) aryloxy, specifically phenyl or phenoxy; R₄ may be (C1-C4)alkylene, (C2-C4)alkenylene, propylene, butylene, or propenylene; Y⁻ may be *—SO₃⁻ or —OSO₃⁻; M⁺ may be an alkali metal ion; and X⁻ may be a halide ion.

The compound represented by Chemical Formula 1 may be represented by the following Chemical Formula 2, and more specifically, may be represented by the following Chemical Formula 3.

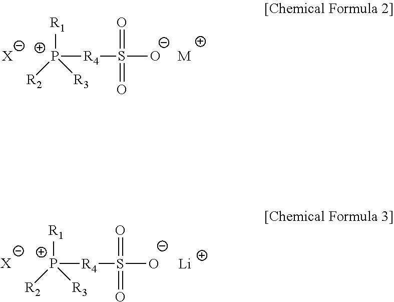

In Chemical Formulas 2 and 3, R₁ to R₄, M⁺, and X⁻ are the same as defined in Chemical Formula 1.

In one embodiment, the additive may be contained in an amount of 0.001 wt % or more, 0.01 wt % or more, 0.1 wt % or more, 0.5 wt % or more, or 0.7 wt % or more, based on the total weight of the non-aqueous electrolyte solution, and may be 10 wt % or less, 7 wt % or less, 5 wt % or less, 3 wt % or less, or an intermediate value between the respective values. More specifically, the additive may be contained in an amount of 0.001 to 10 wt %, 0.01 to 10 wt %, 0.1 to 10 wt %, 0.1 to 7 wt %, 0.1 to 5 wt %, 0.5 to 5 wt %, or 0.7 to 5 wt %. When the above range is satisfied, the output characteristics and stability of a lithium secondary battery to be subsequently produced may be further improved.

The non-aqueous electrolyte solution according to one embodiment may further contain an auxiliary additive, and the auxiliary additive may be one or two or more selected from a fluorine-containing cyclic carbonate-based compound, a vinyl group-containing cyclic carbonate-based compound, a vinylene carbonate-based compound, a cyclic sulfate-based compound, a sultone-based compound, a fluorine-containing lithium phosphate-based compound, a lithium borate-based compound, a lactone-based compound, and a sulfonylimide-based compound.

The fluorine-containing cyclic carbonate-based compound may have a 5- to 7-membered cyclic structure, and may have a fluorine atom directly bonded to a carbon atom or a fluorine-substituted alkyl group bonded thereto. For example, the fluorine-containing cyclic carbonate-based compound may include fluoroethylene carbonate (FEC), difluoroethylene carbonate (DFEC), and trifluoropropylene carbonate (TFPC).

The vinyl group-containing cyclic carbonate-based compound may include, for example, vinyl ethylene carbonate (VES), and the vinylidene carbonate-based compound may include, for example, vinylene carbonate (VC).

The cyclic sulfate-based compound may have a 5- to 7-membered cyclic structure, and may include, for example, ethylene sulfate (ESA), trimethylene sulfate (TMS), methyltrimethylene sulfate (MTMS), and 1,3-propanediol cyclic sulfate. In addition, the cyclic sulfate-based compound may be the bicyclic sulfate-based compound, and the bicyclic sulfate-based compound may include, for example, 2,4,8,10-tetraoxa-3,9-dithiaspiro[5.5]undecane 3,3,9,9-tetraoxide, and 4,4′-bis(1,3,2-dioxathiolane)-2,2,2′,2′-tetraoxide.

The sultone-based compound may have a 5- to 7-membered cyclic structure, and may include ethane sultone, 1,3-propane sultone, butane sultone, and prop-1-ene-1,3-sultone.

When the auxiliary additive is further contained, the auxiliary additive may be contained in an amount of 0.01 to 10 wt %, 0.01 to 5 wt %, 0.01 to 3 wt %, or 0.01 to 1 wt % based on the total weight of the non-aqueous electrolyte solution. In addition, a weight ratio (A:B) of the additive (A) represented by Chemical Formula 1 to the auxiliary additive (B) may be 1:0.1 to 10, 1:0.1 to 7, or 1:0.5 to 5.

The non-aqueous organic solvent may be one or two or more selected from a carbonate-based solvent, an ester-based (carboxylate-based) solvent, an ether-based solvent, a ketone-based solvent, an alcohol-based solvent, and an aprotic solvent.

The carbonate-based solvent may include a linear carbonate-based solvent and a cyclic carbonate-based solvent. The linear carbonate-based solvent may include, for example, dimethyl carbonate (DMC), ethyl methyl carbonate (EMC), diethyl carbonate (DEC), methyl propyl carbonate, ethyl propyl carbonate, and dipropyl carbonate, and the cyclic carbonate-based solvent may include, for example, ethylene carbonate (EC), propylene carbonate (PC), and butylene carbonate.

The ester-based solvent may include a linear ester-based solvent and a cyclic ester-based solvent. The linear ester-based solvent may include, for example, methyl propionate, ethyl propionate, propyl acetate, butyl acetate, and ethyl acetate, and the cyclic ester-based solvent may include, for example, butyrolactone (γ-butyrolactone), caprolactone, and valerolactone (γ-valerolactone).

The ether-based solvent may include dibutyl ether, tetraethylene glycol dimethyl ether (TEGDME), diethylene glycol dimethyl ether (DEGDME), dimethoxyethane, tetrahydrofuran (THF), and 2-methyltetrahydrofuran.

The ketone-based solvent may include acetone, methyl ethyl ketone, methyl n-propyl ketone, methyl n-butyl ketone, methyl isobutyl ketone, diethyl cyclohexanone, methyl cyclohexanone, and acetylacetone, and the alcohol-based solvent may include methanol, ethanol, n-propanol, isopropanol, n-butanol, isobutanol, tert-butanol, 2-ethylhexyl alcohol, and benzyl alcohol.

The aprotic solvent may include at least one selected from a nitrile-based solvent such as acetonitrile, succinonitrile, adiponitrile, or sebaconitrile; an amide-based solvent such as dimethylformamide, dimethylacetamide, or 1-methyl-2-pyrrolidone (NMP); a dioxolane-based solvent such as 1,3-dioxolane; and a sulfolane-based solvent.

Specifically, the non-aqueous organic solvent may be a combination of a linear carbonate-based solvent and a cyclic carbonate-based solvent, and more specifically, may be a combination of ethylene carbonate (EC) and one or two or more selected from ethyl methyl carbonate (EMC), dimethyl carbonate (DMC), and diethyl carbonate (DEC).

The electrolyte salt may be a lithium salt, which may be the lithium salt (Li⁺X⁻), and a conventional lithium salt used in the art may be employed. As a non-limiting example, the anion (X⁻) of the lithium salt may be F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂ (CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻, or (CF₃CF₂SO₂)₂N⁻.

Specifically, the lithium salt may be LiPF₆, LiBF₄, LiSbF₆, LiASF₆, LiClO₄, LiN(C₂F₅SO₂)₂, LiN(CF₃SO₂)₂, CF₃SO₃Li, or LiC(CF₃SO₂)₃, but is not limited thereto.

The lithium salt may be contained at a concentration of 0.01 to 5 M, and preferably 0.01 to 2 M, with respect to the organic solvent. Within the above concentration range, smooth migration of lithium ions and/or electrons during charging and discharging of the battery may be expected, and thus the range is preferred, but is not limited thereto.

In addition, one embodiment of the present invention provides a power storage device including the non-aqueous electrolyte solution.

Hereinafter, a power storage device according to one embodiment will be described in detail. With the exception that the power storage device includes the non-aqueous electrolyte solution according to one embodiment, it will be understood that the power storage device may be manufactured by a structure known in the art using conventional manufacturing methods and materials.

The power storage device may be a general term for a device that is composed of a positive electrode, a negative electrode, and a separator, and that includes a non-aqueous electrolyte solution, and may store and release electric power through a reversible or irreversible reaction.

Specifically, the power storage device may be a lithium battery, and the lithium battery may be a lithium primary battery, a lithium secondary battery, a lithium metal battery, a lithium-sulfur battery, or a lithium-air battery, and more specifically, may be a lithium secondary battery or a lithium metal battery.

The positive electrode may include a positive electrode current collector and a positive electrode active material layer formed on the positive electrode current collector.

As a non-limiting example, the positive electrode current collector may be a foil formed of aluminum, nickel, or a combination thereof, and the positive electrode active material layer may include a positive electrode active material and may further include a binder and a conductive agent, if necessary.

The positive electrode active material may be a conventional positive electrode active material used in the art. As a non-limiting example, the positive electrode active material may be a lithium cobalt composite oxide (LiCoO₂), a spinel-type lithium manganese composite oxide (LiMn₂O₄), a lithium manganese composite oxide (LiMnO₂), a lithium nickel composite oxide (LiNiO₂), lithium manganese phosphate (LiMnPO₄), lithium cobalt phosphate (LiCoPO₄), lithium nickel phosphate (LiNiPO₄), lithium iron phosphate (LiFePO₄), LiFeMnPO₄, lithium iron pyrophosphate (Li₂FeP₂O₇), a lithium niobium composite oxide (LiNbO₂), a lithium iron composite oxide (LiFeO₂), a lithium magnesium composite oxide (LiMgO₂), a lithium copper composite oxide (LiCuO₂), a lithium zinc composite oxide (LiZnO₂), a lithium molybdenum composite oxide (LiMoO₂), a lithium tantalum composite oxide (LiTaO₂), a lithium tungsten composite oxide (LiWO₂), an over-lithiated lithium manganese nickel cobalt composite oxide (xLi₂MnO₃ (1-x) LiMn1-y-zNiyCozO₂), or a lithium nickel cobalt aluminum composite oxide (LiNi_{0.8}Co_{0.15}Al_{0.05}O₂). Preferably, the positive electrode active material may be a composite metal oxide of lithium including one or two or more selected from cobalt, manganese, and nickel, or a lithium-containing olivine-type phosphate containing one or two or more selected from iron, cobalt, nickel, and manganese.

Specifically, the positive electrode active material may be a composite metal oxide of lithium including one or two or more selected from cobalt, manganese, and nickel, and may be LiNiO₂, LiCoO₂, LiMnO₂, LiMn₂O₄, or a nickel-cobalt-manganese-based positive electrode active material represented by the following Chemical Formula 11.

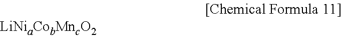

In Chemical Formula 11, a+b+c=1, 0.5<a<1.0, 0<b<0.5, or 0<c<0.5.

For example, a+b+c=1, 0.6<a≤0.9, 0<b≥0.2, and 0<c≤0.2.

Specifically, the positive electrode active material according to one embodiment may be LicoO₂, LiMn₂O₄, LiNiO₂, LiCo₁₋ₓNiₓO₂ (0.01<x<1), LiCo₁/3Ni₁/3Mn₁/3O₂, LiCo_{0.98}Mg_{0.02}O₂, LiNi₁/2Mn₃/2O₄, LiNi_{0.6}Co_{0.2}Mn_{0.2}O₂, LiNi_{0.8}Co_{0.1}Mn_{0.1}O₂, LiNi_{0.88}Co_{0.06}Mn_{0.06}O₂, LiNi_{0.9}Co_{0.05}Mn_{0.05}O₂, or a mixture thereof, but is not limited thereto. In particular, the non-aqueous electrolyte solution according to one embodiment may provide excellent stability even for a high-capacity positive electrode material having low stability, such as LCM811 (LiNi_{0.88}Co_{0.06}Mn_{0.06}O₂).

In addition, the positive electrode active material according to one embodiment may be a lithium-containing olivine-type phosphate such as lithium manganese phosphate (LiMnPO₄), lithium cobalt phosphate (LiCoPO₄), lithium nickel phosphate (LiNiPO₄), lithium iron phosphate (LifePO₄), or LiFeMnPO₄, but is not limited thereto.

As the conductive agent, carbon black such as carbon black, acetylene black, Ketjen black, channel black, furnace black, lamp black, and thermal black; conductive fibers such as carbon fibers and metal fibers; metal powders such as fluorinated carbon, aluminum, and nickel powder; conductive whiskers such zinc oxide and potassium titanate; as conductive metal oxides such as titanium oxide; and conductive materials such as polyphenylene derivatives may be used, but the conductive agent is not particularly limited as long as it has conductivity without causing a chemical change in the battery.

The binder polymer may include one or two more selected from the group consisting of nitrile butadiene rubber, polyethylene glycol, polyacrylonitrile, polyvinyl chloride, polymethyl methacrylate, polypropylene oxide, polydimethylsiloxane, polyvinylidene fluoride, polyvinylidene carbonate, and polyvinylpyrrolidone, and preferably, may be one or two or more selected from the group consisting of polyvinylidene fluoride, polyvinylidene carbonate, and polyethylene glycol, but is not limited thereto.

The negative electrode may include a negative electrode current collector and a negative electrode active material layer formed on the negative electrode current collector.

A non-limiting example of the negative electrode current collector may be a foil formed of copper, gold, nickel, or a copper alloy, or a combination thereof, and the negative electrode active material layer may include a negative electrode active material, and may further include a binder, and a conductive agent, if necessary.

The negative electrode active material may be a conventional negative electrode active material used in the art, and, as a non-limiting example, the negative electrode active material may be a carbon material selected from soft carbon, hard carbon, artificial graphite, natural graphite, expanded graphite, carbon fibers, non-graphitizable carbon, carbon black, carbon nanotubes, acetylene black, Ketjen black, graphene, fullerene, activated carbon, and mesocarbon microbeads; a metal selected from silicon, tin, lithium, aluminum, silver, bismuth, indium, germanium, lead, platinum, titanium, zinc, manganese, cadmium, selenium, copper, cobalt, nickel, and iron; an alloy containing two or more of the metals; and an oxide of one or more of the metals; or lithium metal or a lithium alloy.

In particular, the non-aqueous electrolyte solution according to one embodiment may provide excellent stability even for a lithium metal negative electrode. Specifically, the non-aqueous electrolyte solution according to one embodiment may suppress decomposition of an organic solvent occurring at a specific voltage by forming a solid electrolyte interface (SEI) film on the surface of the negative electrode, and may suppress formation of dendrites on the surface of lithium metal.

In addition, one embodiment of the present invention provides a compound represented by the following Chemical Formula 1.

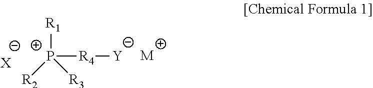

(In Chemical Formula 1,
R₁ to R₃ are each independently hydrogen, halogen, (C1-C10)alkyl, (C2-C10) alkenyl, (C2-C12) alkynyl, (C3-C12) cycloalkyl, (C2-C12) heterocycloalkyl, (C6-C12) aryl, (C2-C12) heteroaryl, (C1-C10) alkoxy, (C2-C10) alkenyloxy, (C2-C10) alkynyloxy, or (C1-C10)alkyl carbonate;
the alkyl, alkenyl, alkynyl, cycloalkyl, heterocycloalkyl, aryl, heteroaryl, alkoxy, aryloxy, alkenyloxy, alkynyloxy, and alkyl carbonate of R₁ to R₃ may each contain one or more halogen atoms;
R₄ may be (C1-C10) alkylene, (C2-C10) alkenylene, (C2-C10) alkynylene, (C3-C12) cycloalkylene, (C2-C12) heterocycloalkylene, (C6-C12) arylene, (C2-C12) heteroarylene, (C1-C10) alkyleneoxy, (C2-C10) alkenyleneoxy, (C2-C10) alkynyleneoxy, (C3-C12) cycloalkyleneoxy, (C6-C12) aryleneoxy, (C2-C12) heteroaryleneoxy, a combination thereof;
Y⁻ is *—SO₃⁻, *—OSO₃⁻, *—OPO₃H⁻, *—CO₂⁻, or *—OCO₂⁻;
M⁺ is an alkali metal ion, ammonium (NH₄⁺), nitrosyl (NO⁺), triethylamine (Et₃N⁺), diazonium (N₂H₅⁺), hydronium (H₃O⁺), phosphonium (PH₄⁺), diphosphonium (P₂H₅⁺), silylium (SiH₃⁺), or pyridinium; and
X⁻ is a halide ion, cyanide (CN⁻), thiocyanate (SCN⁻), cyanate (OCN⁻), acetate (CH₃COO⁻), nitrate (NO₃⁻), nitrite (NO₂⁻), azide (N₃), tetrafluoroborate (BF₄⁻), hexafluorophosphate (PF₆⁻), trifluoromethanesulfonate (CF₃SO₃⁻), tetrafluorozirconate (ZrF₄⁻), tetrafluoroaluminate (AlF₄⁻), bis(fluorosulfonyl)imide (FSI⁻), or bis(trifluoromethanesulfonyl)imide (TFSI⁻).

The compound represented by Chemical Formula 1 according to one embodiment may be used as an additive for a non-aqueous electrolyte solution due to the above-described structural feature.

Specifically, the compound represented by Chemical Formula 1 may exhibit excellent ionic conductivity and solubility because it is a compound having both a cationic portion and an anionic portion, and ionic functional groups are introduced into the cationic portion and the anionic portion of the compound. In addition, by forming a solid electrolyte interface (SEI) film on the surfaces of both the negative electrode and the positive electrode, decomposition of an organic solvent occurring at a specific voltage may be suppressed, thereby significantly improving battery lifespan and stability. In addition, the compound may serve to remove hydrofluoric acid and moisture in the electrolyte solution by itself and may effectively suppress side reactions between the battery and the electrolyte solution.

Hereinafter, the embodiments described above will be described in more detail with reference to Examples. However, the following Examples are for illustrative purposes and do not limit the scope of the present invention.

### <Methods for Evaluating Physical Properties>

### 1. Initial Discharge Capacity

The lithium secondary batteries prepared in the Examples and Comparative Examples were charged for 3 hours in a thermostatic chamber at 25° C. under a constant current of 1 C and a constant voltage up to a cutoff voltage of 4.2 V, and were then discharged at a constant current of 1 C down to a cutoff voltage of 3.0 V to measure the initial discharge capacity (C1).

### 2. Capacity Retention

For the lithium secondary batteries prepared in the Examples and Comparative Examples, charging and discharging were repeatedly performed 500 times according to the measurement method of the initial discharge capacity, and the discharge capacity at the 500th cycle (C2) was measured to calculate the capacity retention.

$$Capacity retention ( \% ) = C 2 / C 1 \times 100$$

### 3. Output Characteristics

The lithium secondary batteries prepared in the Examples and Comparative Examples were charged by 1 C CC/CV charging (4.2 V CUT-OFF) and then discharged by 20 CC discharging to 150 mA. Thereafter, the C-rate was varied to 0.5 C, 1 C, 2 C, and 4 C, and discharging and recharging were performed for 10 seconds at each rate to measure DCIR. The output (pulse power) value was calculated using the measured DCIR value.

### <Preparation of Additives>

### Example 1

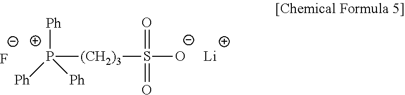

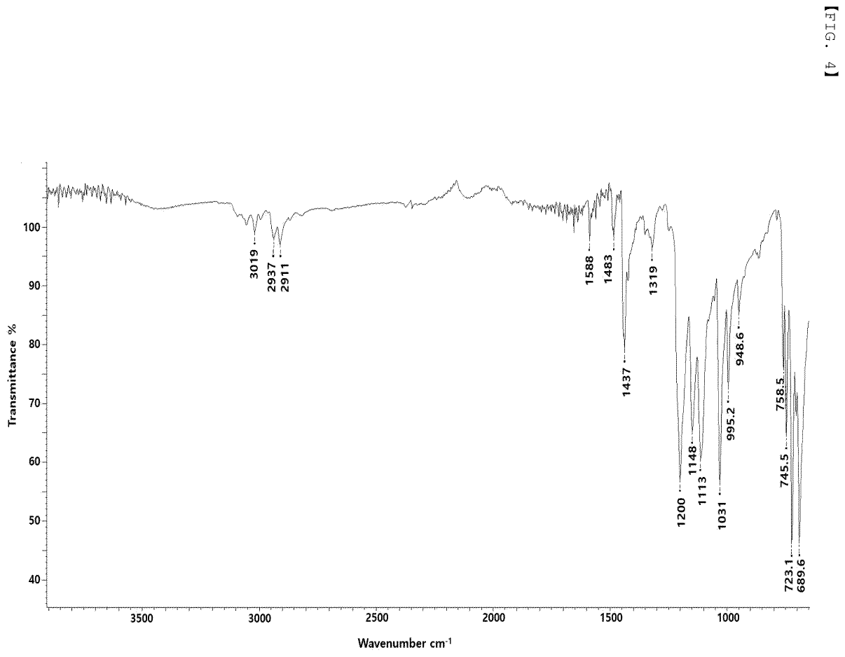

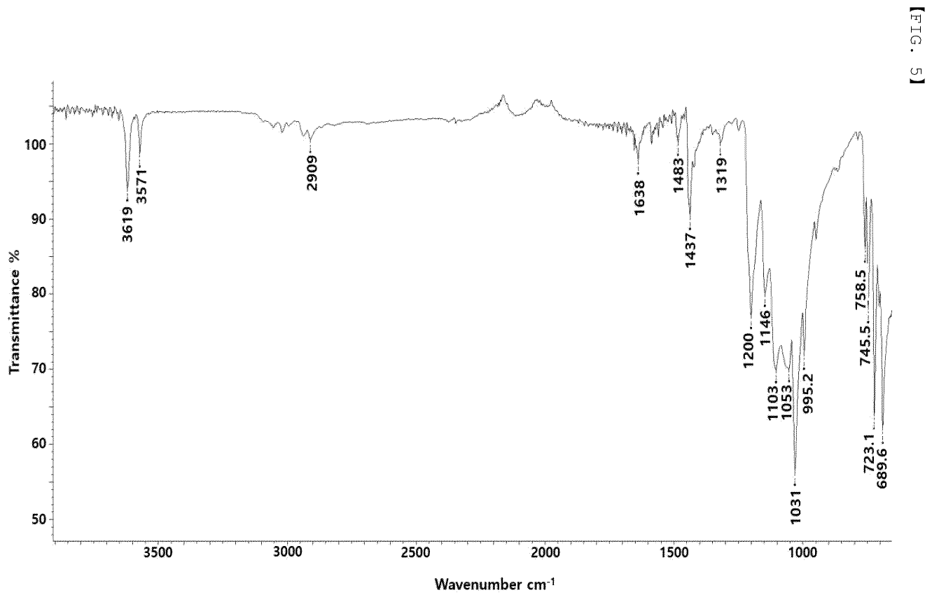

A reactor equipped with a condenser on the top was charged with 1,000 g of a toluene solvent, 100 g of triphenylphosphine, 46.6 g of propane sultone (1,3-propanesultone), and 9.9 g of lithium fluoride (LiF), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting white powder was further dried under vacuum at 60° C. for 24 hours to obtain an additive having the structure of Chemical Formula 5 in the form of a white solid (yield: 70%). The structure was confirmed using infrared absorption spectroscopy (FT-IR spectrometer), and the results are illustrated in FIG. 2.

### Example 2

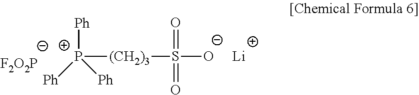

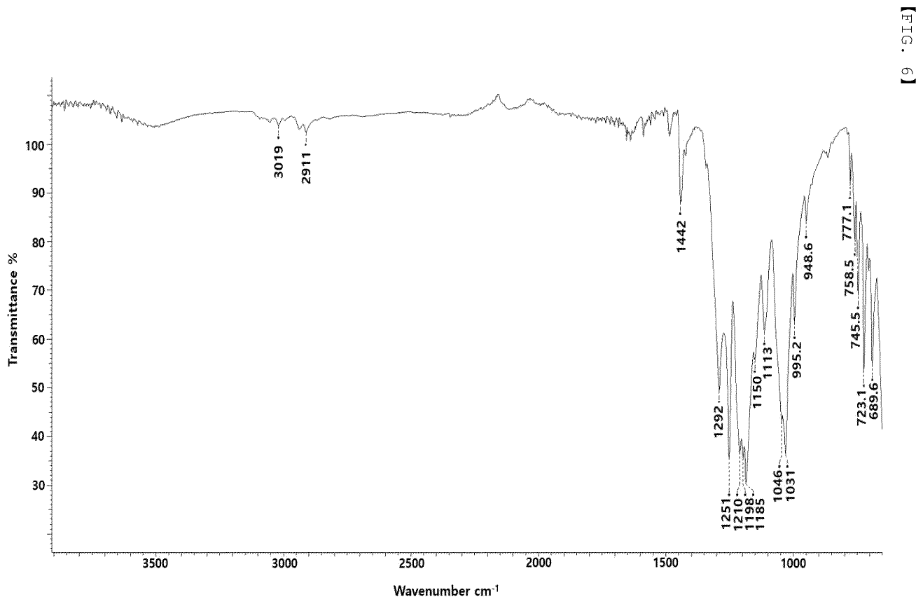

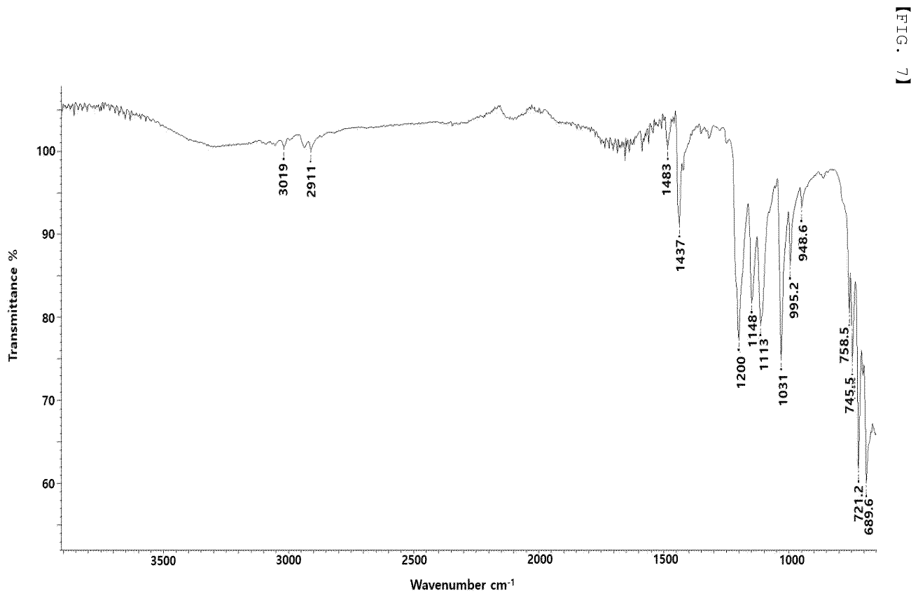

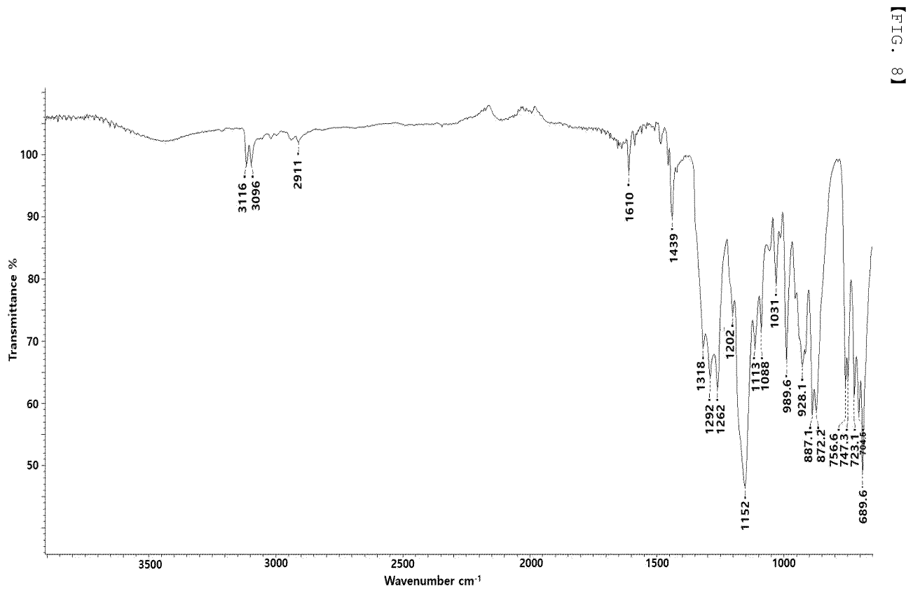

A reactor equipped with a condenser on the top was charged with 1,000 g of a toluene solvent, 100 g of triphenylphosphine, 46.6 g of propane sultone (1,3-propanesultone), and 46.4 g of lithium difluorophosphate (LiPO₂F₂), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 164.6 g of an additive having the structure of Chemical Formula 6 in the form of a colorless and transparent liquid (yield: 88%). The structure was confirmed using infrared absorption spectroscopy (FT-IR spectrometer), and the results are illustrated in FIG. 3.

### Example 3

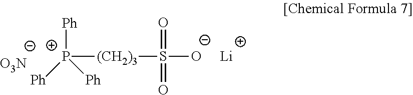

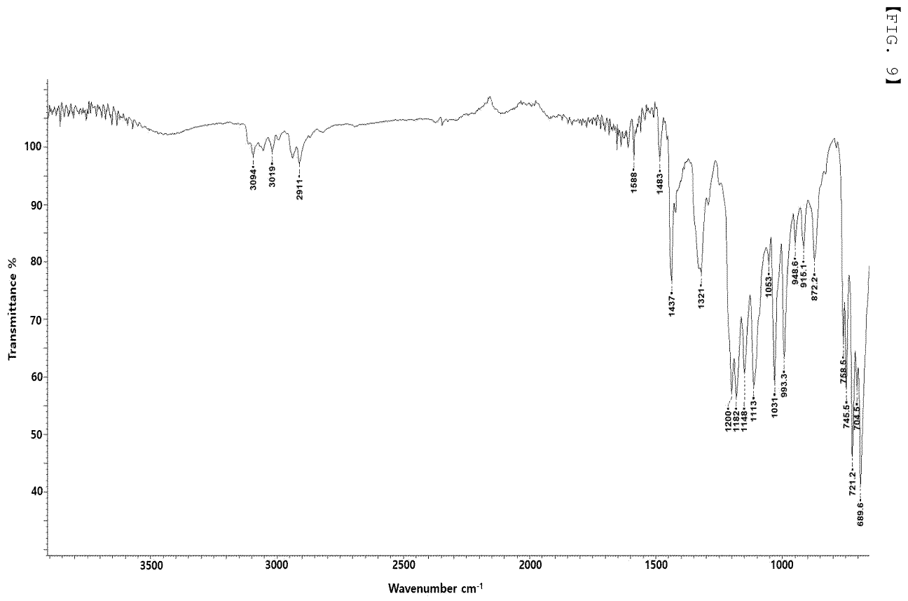

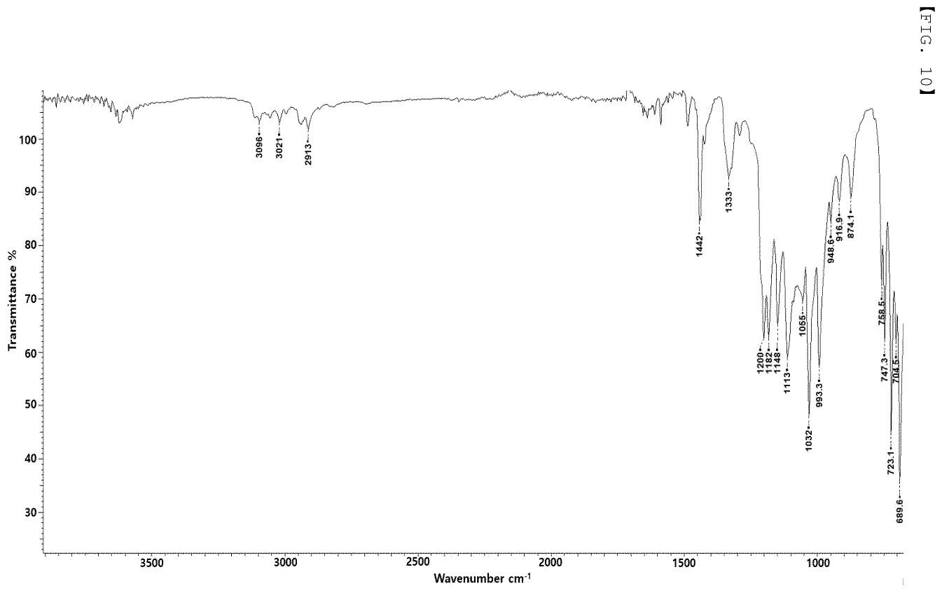

A reactor equipped with a condenser on the top was charged with 1,000 g of a toluene solvent, 100 g of triphenylphosphine, 46.6 g of propane sultone (1,3-propanesultone), and 26.3 g of lithium nitrate (LiNO₃), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 158.5 g of an additive having the structure of Chemical Formula 7 in the form of a colorless and transparent liquid (yield: 92%). The structure was confirmed using infrared absorption spectroscopy (FT-IR spectrometer), and the results are illustrated in FIG. 4.

### Example 4

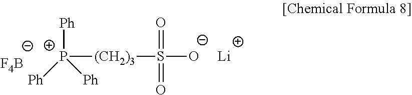

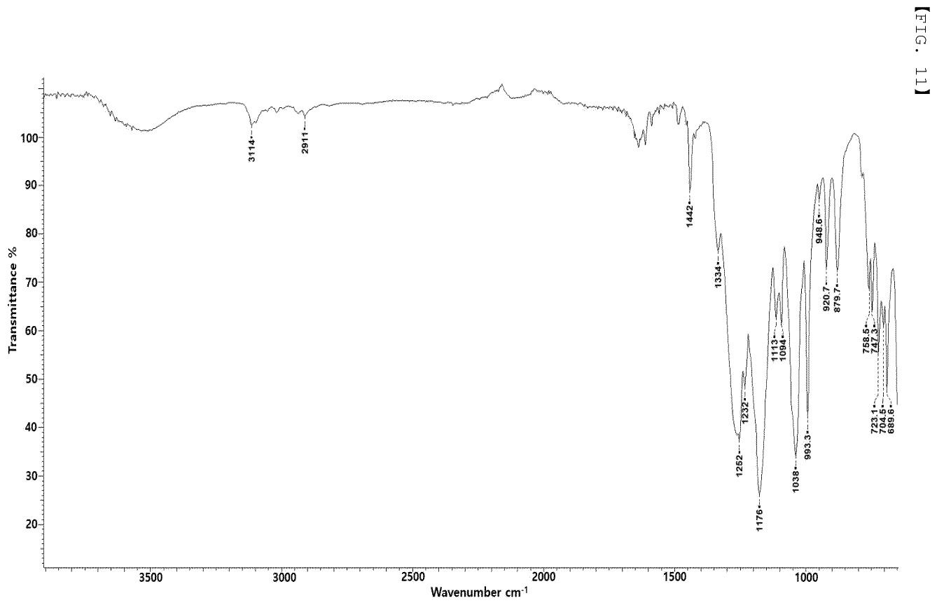

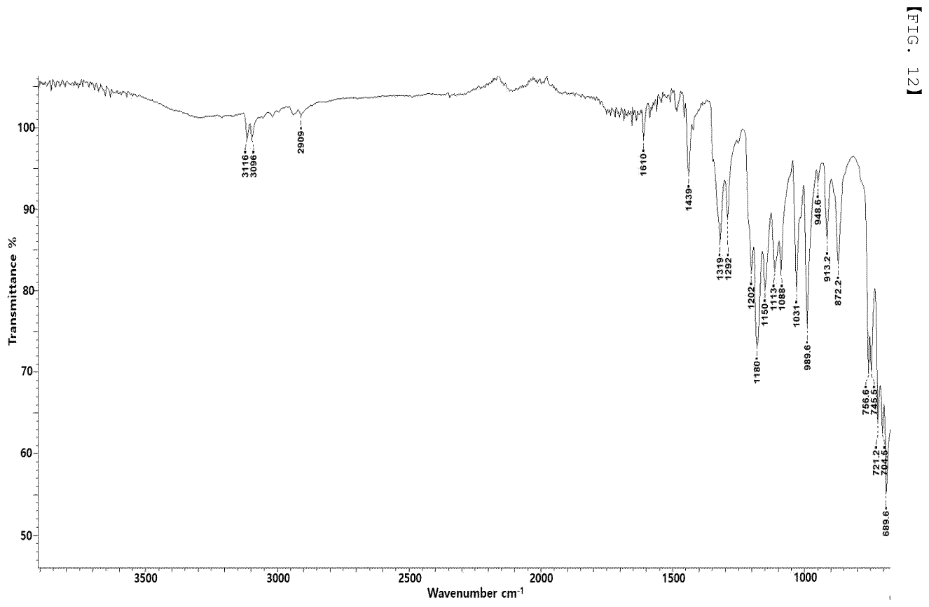

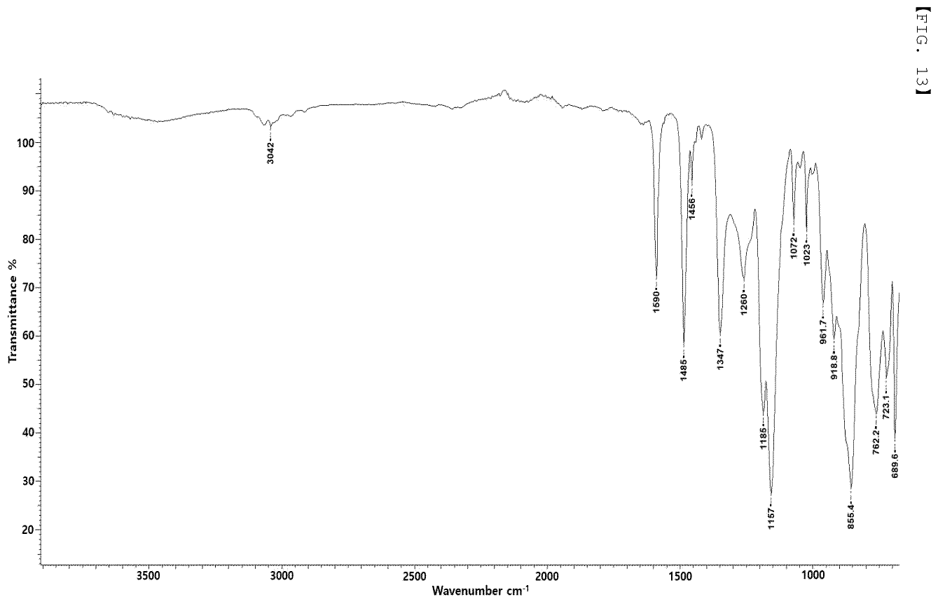

A reactor equipped with a condenser on the top was charged with 1,000 g of a toluene solvent, 100 g of triphenylphosphine, 46.6 g of propane sultone (1,3-propanesultone), and 35.8 g of lithium tetrafluoroborate (LiBF₄), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 165.4 g of an additive having the structure of Chemical Formula 8 in the form of a colorless and transparent liquid (yield: 91%). The structure was confirmed using infrared absorption spectroscopy (FT-IR spectrometer), and the results are illustrated in FIG. 5.

### Example 5

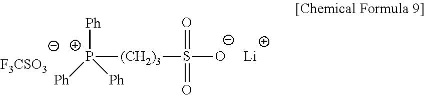

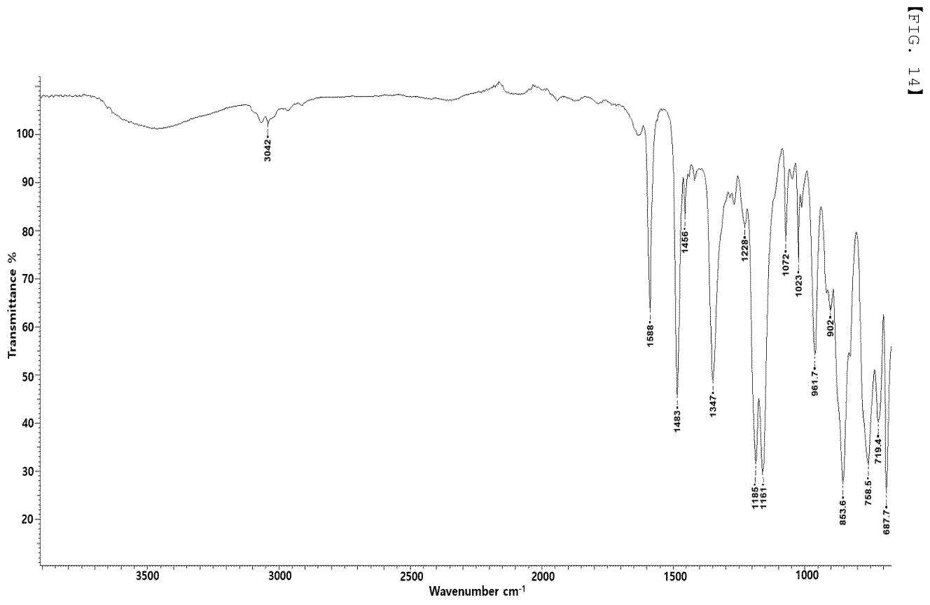

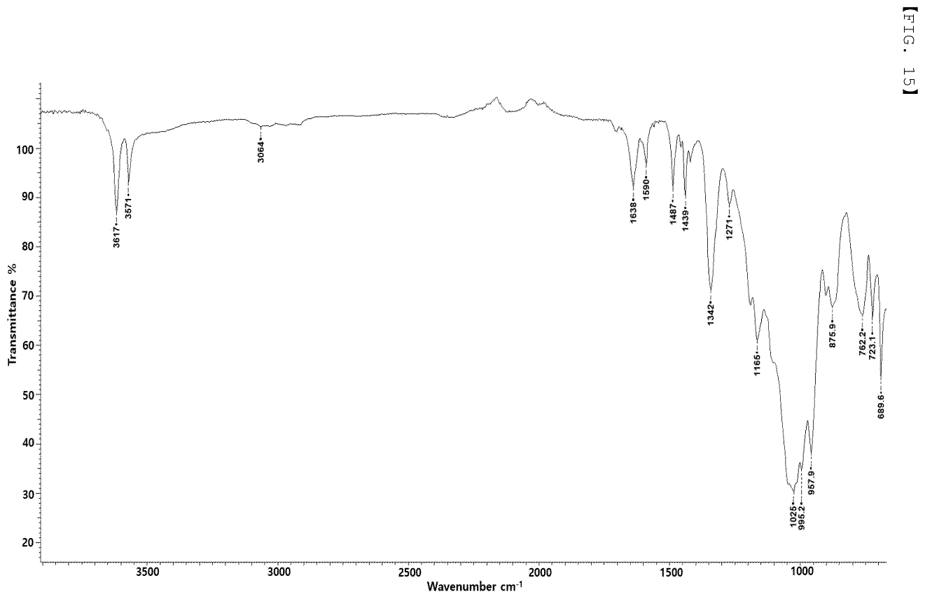

A reactor equipped with a condenser on the top was charged with 1,000 g of a toluene solvent, 100 g of triphenylphosphine, 46.6 g of propane sultone (1,3-propanesultone), and 59.5 g of lithium trifluoromethanesulfonate (CF₃SO₃Li), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 193.0 g of an additive having the structure of Chemical Formula 9 in the form of a colorless and transparent liquid (yield: 94%). The structure was confirmed using infrared absorption spectroscopy (FT-IR spectrometer), and the results are illustrated in FIG. 6.

### Example 6

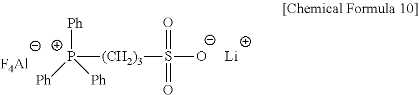

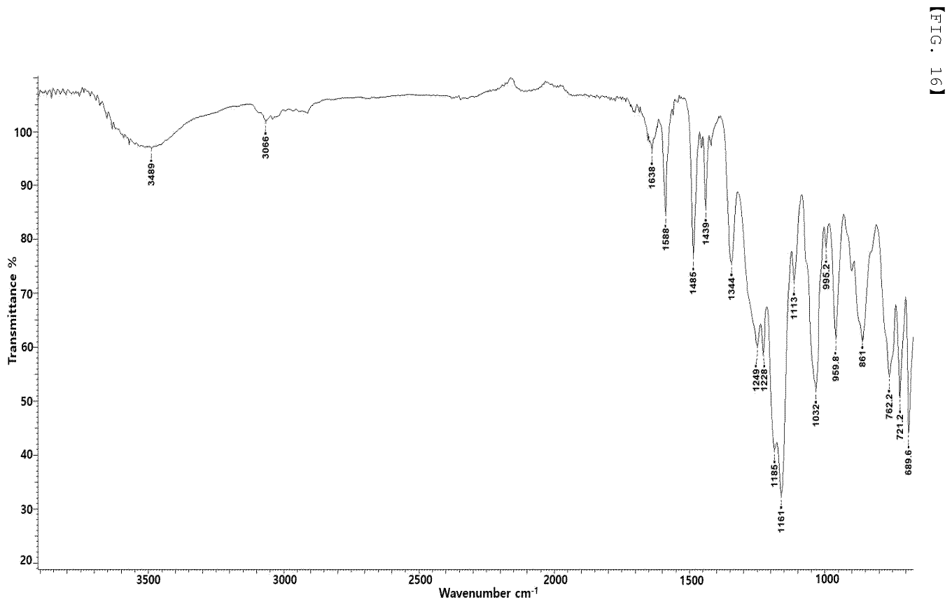

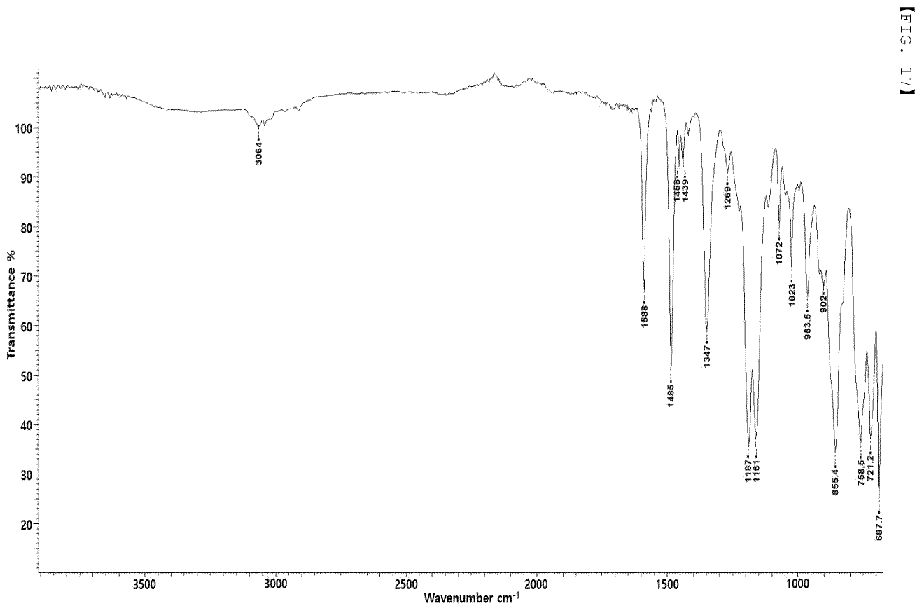

A reactor equipped with a condenser on the top was charged with 1,000 g of a toluene solvent, 100 g of triphenylphosphine, 46.6 g of propane sultone (1,3-propanesultone), and 41.9 g of lithium tetrafluoroaluminate (LiAlF₄), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 157.8 g of an additive having the structure of Chemical Formula 10 in the form of a colorless and transparent liquid (yield: 82%). The structure was confirmed using infrared absorption spectroscopy (FT-IR spectrometer), and the results are illustrated in FIG. 7.

### Example 7

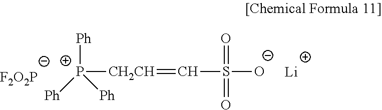

A reactor equipped with a condenser on the top was charged with 1,000 g of a toluene solvent, 100 g of triphenylphosphine, 45.8 g of propene sultone (1-propene-1,3-sultone), g of lithium difluorophosphate (LiPO₂F₂), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 145.3 g of an additive having the structure of Chemical Formula 11 in the form of a colorless and transparent liquid (yield: 78%). The structure was confirmed using infrared absorption spectroscopy (FT-IR spectrometer), and the results are illustrated in FIG. 8.

### Example 8

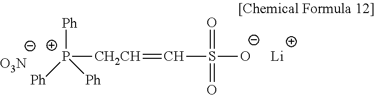

A reactor equipped with a condenser on the top was charged with 1,000 g of a toluene solvent, 100 g of triphenylphosphine, 45.8 g of propene sultone (1-propene-1,3-sultone), and 26.3 g of lithium nitrate (LiNO₃), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 157.8 g of an additive having the structure of Chemical Formula 12 in the form of a colorless and transparent liquid (yield: 92%). The structure was confirmed using infrared absorption spectroscopy (FT-IR spectrometer), and the results are illustrated in FIG. 9.

### Example 9

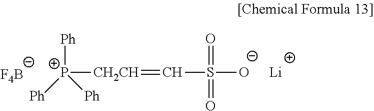

A reactor equipped with a condenser on the top was charged with 1,000 g of a toluene solvent, 100 g of triphenylphosphine, 45.8 g of propene sultone (1-propene-1,3-sultone), and 35.8 g of lithium tetrafluoroborate (LiBF₄), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 166.5 g of an additive having the structure of Chemical Formula 13 in the form of a colorless and transparent liquid (yield: 92%).

The structure was confirmed using infrared absorption spectroscopy (FT-IR spectrometer), and the results are illustrated in FIG. 10.

### Example 10

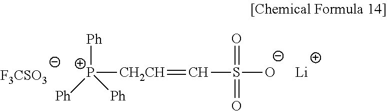

A reactor equipped with a condenser on the top was charged with 1,000 g of a toluene solvent, 100 g of triphenylphosphine, 45.8 g of propene sultone (1-propene-1,3-sultone), and 59.5 g of lithium trifluoromethanesulfonate (CF₃SO₃Li), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 169.8 g of an additive having the structure of Chemical Formula 14 in the form of a colorless and transparent liquid (yield: 83%). The structure was confirmed using infrared absorption spectroscopy (FT-IR spectrometer), and the results are illustrated in FIG. 11.

### Example 11

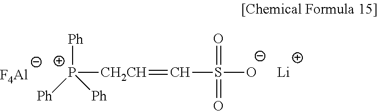

A reactor equipped with a condenser on the top was charged with 1,000 g of a toluene solvent, 100 g of triphenylphosphine, 45.8 g of propene sultone (1-propene-1,3-sultone), and 42.0 g of lithium tetrafluoroaluminate (LiAlF₄), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 144.0 g of an additive having the structure of Chemical Formula 15 in the form of a colorless and transparent liquid (yield: 778). The structure was confirmed using infrared absorption spectroscopy (FT-IR spectrometer), and the results are illustrated in FIG. 12.

### Example 12

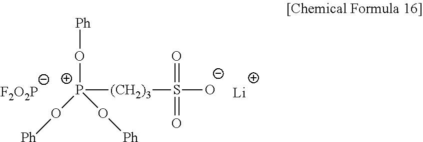

A reactor equipped with a condenser on the top was charged with 1,000 g of a toluene solvent, 100 g of triphenyl phosphite ((C6H₅-0) 3-P), 39.4 g of propane sultone (1,3-propanesultone), and 34.8 g of lithium difluorophosphate (LiPO₂F₂), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 135.8 g of an additive having the structure of Chemical Formula 16 in the form of a colorless and transparent liquid (yield: 78%). The structure was confirmed using infrared absorption spectroscopy (FT-IR spectrometer), and the results are illustrated in FIG. 13.

### Example 13

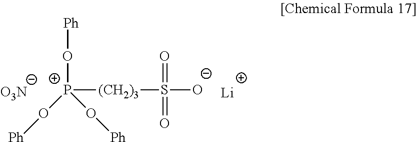

A reactor equipped with a condenser on the top was charged with 1,000 g of a toluene solvent, 100 g of triphenyl phosphite ((C₆H₅—O)₃—P), 39.4 g of propane sultone (1,3-propanesultone), and 22.2 g of lithium nitrate (LiNO₃), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 130.9 g of an additive having the structure of Chemical Formula 17 in the form of a colorless and transparent liquid (yield: 81%). The structure was confirmed using infrared absorption spectroscopy (FT-IR spectrometer), and the results are illustrated in FIG. 14.

### Example 14

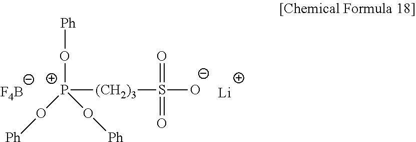

A reactor equipped with a condenser on the top was charged with 1,000 g of a toluene solvent, 100 g of triphenyl phosphite ((C₆H₅—O)₃—P), 39.4 g of propane sultone (1,3-propanesultone), and 30.2 g of lithium tetraborate (LiBF₄), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 156.0 g of an additive having the structure of Chemical Formula 18 in the form of a colorless and transparent liquid (yield: 92%). The structure was confirmed using infrared absorption spectroscopy (FT-IR spectrometer), and the results are illustrated in FIG. 15.

### Example 15

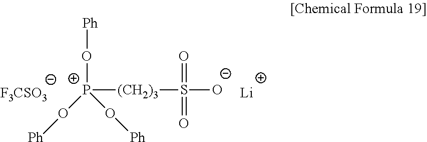

A reactor equipped with a condenser on the top was charged with 1,000 g of a toluene solvent, 100 g of triphenyl phosphite ((C₆H₅—O)₃—P), 39.4 g of propane sultone (1,3-propanesultone), and 50.3 g of lithium trifluoromethanesulfonate (CF₃SO₃Li), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 146.3 g of an additive having the structure of Chemical Formula 19 in the form of a colorless and transparent liquid (yield: 77%). The structure was confirmed using infrared absorption spectroscopy (FT-IR spectrometer), and the results are illustrated in FIG. 16.

### Example 16

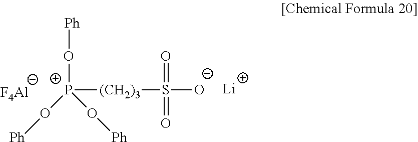

A reactor equipped with a condenser on the top was charged with 1,000 g of a toluene solvent, 100 g of triphenyl phosphite ((C₆H₅—O)₃—P), 39.4 g of propane sultone (1,3-propanesultone), and 35.4 g of lithium tetrafluoroaluminate (LiAlF₄), the mixture was heated to a temperature at which the solvent vaporized, stirred for 24 hours, and then allowed to stand to naturally cool to room temperature after completion of the reaction, and the resulting mixture was filtered to remove solids. The remaining solution was subjected to reduced-pressure distillation to remove the solvent, and the resulting colorless and transparent liquid was further dried under vacuum at 60° C. for 24 hours to obtain 127.6 g of an additive having the structure of Chemical Formula 20 in the form of a colorless and transparent liquid (yield: 73%). The structure was confirmed using infrared absorption spectroscopy (FT-IR spectrometer), and the results are illustrated in FIG. 17.

### <Preparation of Non-Aqueous Electrolyte Solution and Lithium Secondary Battery>

### Example 17

### Preparation of Non-Aqueous Electrolyte Solution

A 1.0 M LiPF₆ solution was prepared using a mixed solvent obtained by mixing ethylene carbonate (EC) and ethyl methyl carbonate (EMC) at a volume ratio of 3:7 (v/v). A non-aqueous electrolyte solution was prepared by adding the additive (Chemical Formula 5) obtained in Example 1 to the LiPF₆ solution so that the amount of the additive was 0.5 wt % based on the total weight (100 wt %) of the electrolyte solution.

### Preparation of Lithium Secondary Battery

A positive electrode mixture paste was prepared by dissolving and mixing NCM811 (Li(Ni_{0.8}Co_{0.1}Mn_{0.1})O₂), acetylene black, and polyvinylidene fluoride (PVDF) in N-methyl-2-pyrrolidone (NMP) at a weight ratio of 94:3:2. The positive electrode mixture paste was applied to one surface of an aluminum foil (current collector, thickness: 20 μm), dried, pressed, and then punched into a predetermined size to produce a positive electrode sheet. The density of the positive electrode, excluding the current collector, was 3.58 g/cm³.

In addition, a negative electrode mixture paste was prepared by dissolving and mixing crystalline artificial graphite (d₀₀₂=0.335 nm), acetylene black, and polyvinylidene fluoride (PVDF) in N-methyl-2-pyrrolidone (NMP) at a ratio of 92:1:7. The negative electrode mixture paste was applied to one surface of a copper foil (current collector, thickness: 15 μm), dried, pressed, and then punched into a predetermined size to produce a negative electrode sheet. The density of the negative electrode, excluding the current collector, was 1.5 g/cm³.

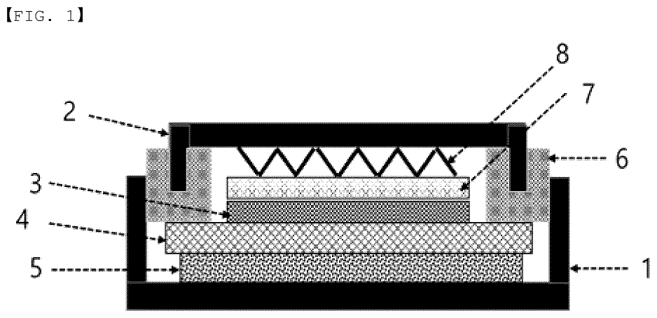

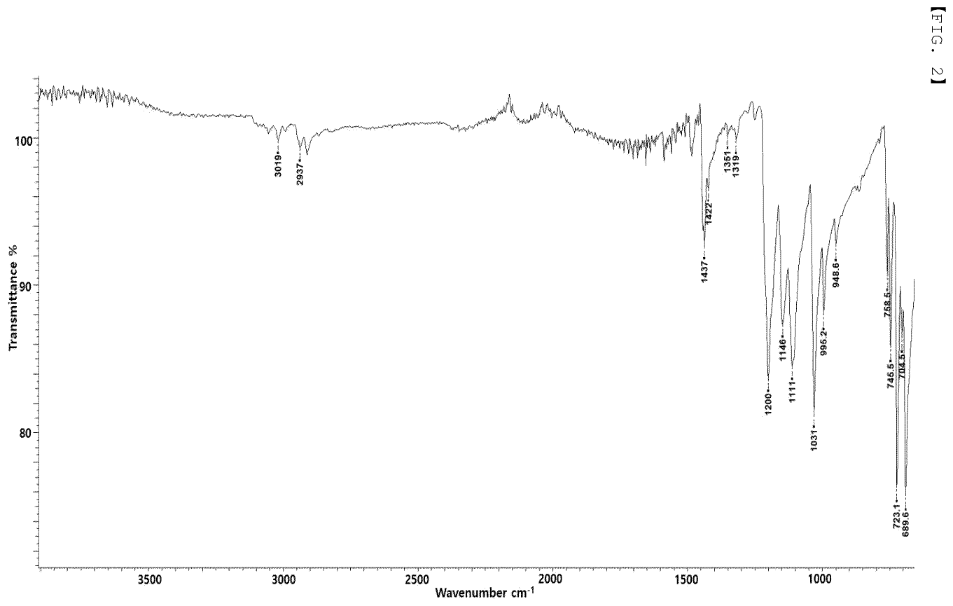

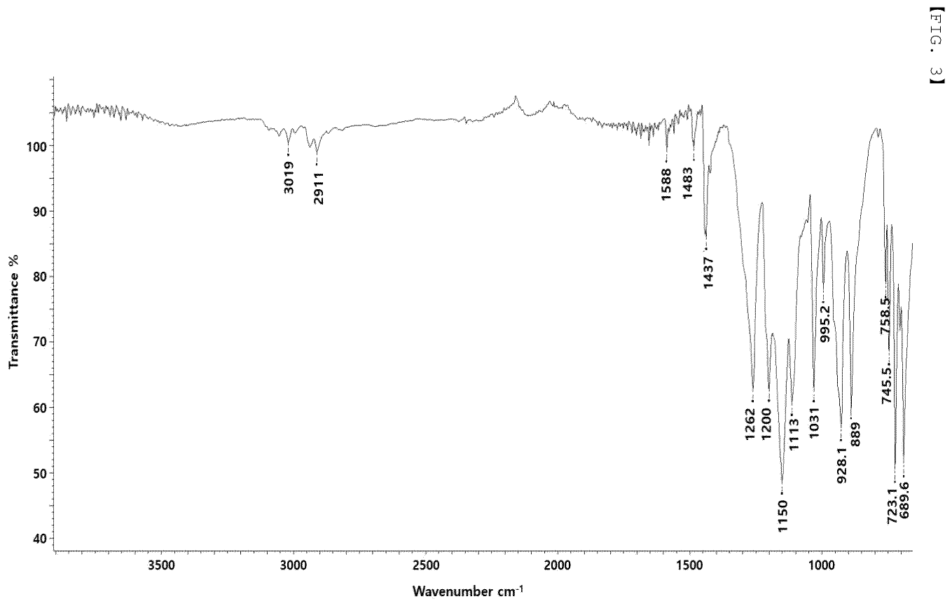

The positive electrode sheet obtained above, a separator (microporous polyethylene film), and the negative electrode sheet obtained above were sequentially stacked in this order, and the non-aqueous electrolyte solution obtained above was injected and sealed to prepare a coin-type lithium secondary battery (3048 type) (FIG. 1). The electrochemical characteristics of the prepared lithium secondary battery were evaluated by the method described in the methods for evaluating physical properties, and the results are shown in Table 2.

### Examples 18 to 37 and Comparative Examples 1 to 9

The procedure was performed in the same manner as in Example 17, except that the type and content of the additive were changed as shown in Table 1 in the preparation of the non-aqueous electrolyte solution. The electrochemical characteristics of the prepared lithium secondary battery were evaluated by the method described in the methods for measuring physical properties, and the results are shown in Table 2.

TABLE 1

| | Additive | | Auxiliary additive | |
|---|---|---|---|---|
| | Type | Content | Type | Content |
| Example 17 | Chemical Formula 5 | 0.5 wt % | — | — |
| Example 18 | Chemical Formula 5 | 1.0 wt % | — | — |
| Example 19 | Chemical Formula 5 | 2.0 wt % | — | — |
| Example 20 | Chemical Formula 5 | 1.0 wt % | B-1 | 1.0 wt % |
| Example 21 | Chemical Formula 5 | 1.0 wt % | B-2 | 1.0 wt % |
| Example 22 | Chemical Formula 5 | 1.0 wt % | B-3 | 1.0 wt % |
| Example 23 | Chemical Formula 6 | 1.0 wt % | — | — |
| Example 24 | Chemical Formula 7 | 1.0 wt % | — | — |
| Example 25 | Chemical Formula 8 | 1.0 wt % | — | — |
| Example 26 | Chemical Formula 9 | 1.0 wt % | — | — |
| Example 27 | Chemical Formula 10 | 1.0 wt % | — | — |
| Example 28 | Chemical Formula 11 | 1.0 wt % | — | — |
| Example 29 | Chemical Formula 12 | 1.0 wt % | — | — |
| Example 30 | Chemical Formula 13 | 1.0 wt % | — | — |
| Example 31 | Chemical Formula 14 | 1.0 wt % | — | — |
| Example 32 | Chemical Formula 15 | 1.0 wt % | — | — |
| Example 33 | Chemical Formula 16 | 1.0 wt % | — | — |
| Example 34 | Chemical Formula 17 | 1.0 wt % | — | — |
| Example 35 | Chemical Formula 18 | 1.0 wt % | — | — |
| Example 36 | Chemical Formula 19 | 1.0 wt % | — | — |
| Example 37 | Chemical Formula 20 | 1.0 wt % | — | — |
| Comparative | A-1 | 0.5 wt % | — | — |
| Example 1 | | | | |
| Comparative | A-1 | 1.0 wt % | — | — |
| Example 2 | | | | |
| Comparative | A-2 | 1.0 wt % | — | — |
| Example 3 | | | | |
| Comparative | A-3 | 1.0 wt % | — | — |
| Example 4 | | | | |
| Comparative | A-4 | 1.0 wt % | — | — |
| Example 5 | | | | |
| Comparative | A-1 | 1.0 wt % | B-1 | 1.0 wt % |
| Example 6 | | | | |
| Comparative | A-2 | 1.0 wt % | B-1 | 1.0 wt % |
| Example 7 | | | | |
| Comparative | A-3 | 1.0 wt % | B-1 | 1.0 wt % |
| Example 8 | | | | |
| Comparative | A-4 | 1.0 wt % | B-1 | 1.0 wt % |
| Example 9 | | | | |

A-1: Lithium difluorophosphate
A-2: Lithium tetrafluorophosphate
A-3: Lithium difluoro(bisoxalato)phosphate (LIDFBOP)
A-4: Lithium bis(oxalato)borate
B-1: Vinylene carbonate
B-2: Vinyl ethylene carbonate
B-3: Fluoroethylene carbonate

TABLE 2

| | Lifespan characteristics at | | | |
|---|---|---|---|---|
| | 25° C. (room temperature) | | | Output |
| | | Capacity | | characteristics |
| | Initial | at 500th | Capacity | at 25° C. |
| | capacity | cycle (mAh) | retention | Output |
| | (C1, mAh) | (C2, mAh ) | (%) | (W) |
| Example 17 | 297.3 | 280.1 | 94.2 | 62.3 |
| Example 18 | 298.3 | 284.6 | 95.4 | 65.7 |
| Example 19 | 298.7 | 284.7 | 95.3 | 64.8 |
| Example 20 | 299.1 | 286.2 | 95.7 | 65.4 |
| Example 21 | 299.2 | 286.0 | 95.6 | 65.1 |
| Example 22 | 298.9 | 285.4 | 95.5 | 65.6 |
| Example 23 | 297.6 | 280.1 | 94.2 | 66.3 |
| Example 24 | 298.7 | 284.6 | 95.4 | 65.7 |
| Example 25 | 298.5 | 284.7 | 95.3 | 63.8 |
| Example 26 | 299.4 | 286.2 | 95.7 | 66.4 |
| Example 27 | 299.7 | 286.0 | 95.6 | 64.1 |
| Example 28 | 298.5 | 285.4 | 95.5 | 67.6 |
| Example 29 | 298.6 | 287.7 | 96.3 | 65.7 |
| Example 30 | 298.7 | 286.5 | 95.9 | 66.3 |
| Example 31 | 298.8 | 284.3 | 95.1 | 67.2 |
| Example 32 | 298.4 | 282.7 | 94.7 | 66.3 |
| Example 33 | 298.3 | 284.3 | 95.3 | 66.4 |
| Example 34 | 298.2 | 283.7 | 95.1 | 66.7 |
| Example 35 | 298.6 | 285.6 | 95.6 | 65.5 |
| Example 36 | 298.7 | 286.7 | 96.0 | 65.4 |
| Example 37 | 298.8 | 287.5 | 96.2 | 64.7 |
| Comparative | 298.3 | 254.4 | 85.3 | 54.7 |
| Example 1 | | | | |
| Comparative | 297.5 | 242.8 | 81.6 | 62.3 |
| Example 2 | | | | |
| Comparative | 297.3 | 242.8 | 78.9 | 52.6 |
| Example 3 | | | | |
| Comparative | 297.6 | 252.1 | 84.7 | 60.9 |
| Example 4 | | | | |
| Comparative | 297.7 | 253.6 | 85.2 | 56.2 |
| Example 5 | | | | |
| Comparative | 298.2 | 273.4 | 91.7 | 60.2 |
| Example 6 | | | | |
| Comparative | 298.4 | 256.0 | 85.8 | 55.4 |
| Example 7 | | | | |
| Comparative | 298.1 | 270.4 | 90.7 | 58.8 |
| Example 8 | | | | |
| Comparative | 298.1 | 267.7 | 89.8 | 59.7 |
| Example 9 | | | | |

Referring to Table 2, it can be seen that the lithium secondary battery according to the present invention, as a result of containing a compound represented by any one of Chemical Formulas 5 to 20 as an additive in the electrolyte solution, exhibits improvements in all of the initial discharge capacity, lifespan characteristics, and output characteristics, compared with the lithium secondary batteries of the Comparative Examples using a conventional commercial electrolyte solution additive. In particular, it can be seen that, in the case of the Examples in which the additive represented by any one of Chemical Formulas 5 to 20 was used alone, the lifespan characteristics and output characteristics are significantly improved compared with Comparative Examples 1 to 9, in which a conventional electrolyte solution additive and an additional auxiliary additive were used together.
1: Positive electrode can
2: Negative electrode can
3: Positive electrode
4: Separator
5: Negative electrode
6: Gasket
7: Spacer disc
8: Spring

1. A non-aqueous electrolyte solution comprising:
a non-aqueous organic solvent;
an electrolyte salt; and
one or two or more additives selected from compounds represented by the following Chemical Formula 1: 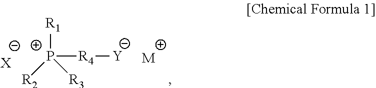
wherein, in Chemical Formula 1:
R₁ to R₃ are each independently hydrogen, halogen, (C1-C10)alkyl, (C2-C10) alkenyl, (C2-C10) alkynyl, (C3-C12) cycloalkyl, (C2-C12) heterocycloalkyl, (C6-C12) aryl, (C2-C12) heteroaryl, (C1-C10) alkoxy, (C6-C12) aryloxy, (C2-C10) alkenyloxy, (C2-C10) alkynyloxy, or (C1-C10)alkyl carbonate;
the alkyl, alkenyl, alkynyl, cycloalkyl, heterocycloalkyl, aryl, heteroaryl, alkoxy, aryloxy, alkenyloxy, alkynyloxy, and alkyl carbonate of R₁ to R₃ may each contain one or more halogen atoms;
R₄ may be (C1-C10) alkylene, (C2-C10) alkenylene, (C2-C10) alkynylene, (C3-C12) cycloalkylene, (C2-C12) heterocycloalkylene, (C6-C12) arylene, (C2-C12) heteroarylene, (C1-C10) alkyleneoxy, (C2-C10) alkenyleneoxy, (C2-C10) alkynyleneoxy, (C3-C12) cycloalkyleneoxy, (C6-C12) aryleneoxy, (C2-C12) heteroaryleneoxy, or a combination thereof;
Y⁻ is *—SO₃⁻, *—OSO₃⁻, *—OPO₃H⁻, *—CO₂⁻, or *—OCO₂⁻;
M⁺ is an alkali metal ion, ammonium (NH₄⁺), nitrosyl (NO⁺), triethylamine (Et₃N⁺), diazonium (N₂H₅⁺), hydronium (H₃O⁺), phosphonium (PH₄⁺), diphosphonium (P₂H₅⁺), silylium (SiH₃⁺), or pyridinium; and
X⁻ is a halide ion, cyanide (CN⁻), thiocyanate (SCN⁻), cyanate (OCN⁻), acetate (CH₃COO⁻), nitrate (NO₃⁻), nitrite (NO₂⁻), azide (N₃⁻), tetrafluoroborate (BF₄⁻), hexafluorophosphate (PF₆⁻), trifluoromethanesulfonate (CF₃SO₃⁻), tetrafluorozirconate (ZrF₄⁻), tetrafluoroaluminate (AlF₄⁻), difluorophosphate (PO₂F₂⁻), bis(fluorosulfonyl)imide (FSI), or bis(trifluoromethanesulfonyl)imide (TFSI).

2. The non-aqueous electrolyte solution of claim 1, wherein the compound represented by Chemical Formula 1 is represented by the following Chemical Formula 2: 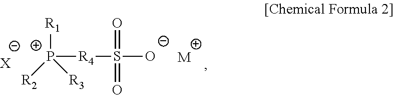
wherein in Chemical Formula 2:
R₁ to R₄, M⁺, and X⁻ are the same as defined in claim 1.

3. The non-aqueous electrolyte solution of claim 1, wherein the compound represented by Chemical Formula 1 is represented by the following Chemical Formula 3: 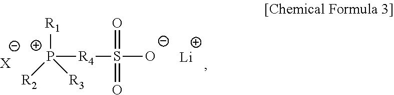
wherein in Chemical Formula 3:
R₁ to R₄ and X⁻ are the same as defined in claim 1.

4. The non-aqueous electrolyte solution of claim 1, wherein R₁ to R₃ are each independently (C6-C12) aryl, (C6-C12) aryloxy, or (C2-C12) heteroaryl; R₄ is (C1-C4) alkylene or (C2-C4)alkenylene; and X⁻ is F⁻, nitrate (NO₃⁻), tetrafluoroborate (BF₄⁻), hexafluorophosphate (PF₆⁻), trifluoromethanesulfonate (CF₃SO₃⁻), tetrafluorozirconate (ZrF₄⁻), tetrafluoroaluminate (AlF₄⁻), difluorophosphate (PO₂F₂⁻), bis(fluorosulfonyl)imide (FSI⁻), or bis(trifluoromethanesulfonyl)imide (TFSI⁻).

5. The non-aqueous electrolyte solution of claim 1, wherein the additive is contained in an amount of 0.001 to 10 mass % based on the total weight of the non-aqueous electrolyte solution.

6. The non-aqueous electrolyte solution of claim 1, wherein the non-aqueous organic solvent is one or two or more selected from the group consisting of a linear carbonate-based solvent, a cyclic carbonate-based solvent, a linear ester-based solvent, a cyclic ester-based solvent, an ether-based solvent, a ketone-based solvent, an alcohol-based solvent, and an aprotic solvent.

7. The non-aqueous electrolyte solution of claim 6, wherein the non-aqueous organic solvent is a combination of a linear carbonate-based solvent and a cyclic carbonate-based solvent.

8. The non-aqueous electrolyte solution of claim 1, wherein the electrolyte salt is a lithium salt.

9. The non-aqueous electrolyte solution of claim 1, further comprising one or two or more auxiliary additives selected from the group consisting of a fluorine-containing cyclic carbonate-based compound, a vinyl group-containing cyclic carbonate-based compound, a vinylene carbonate-based compound, a cyclic sulfate-based compound, a sultone-based compound, a fluorine-containing lithium phosphate-based compound, a lithium borate-based compound, a lactone-based compound, and a sulfonylimide-based compound.

10. The non-aqueous electrolyte solution of claim 9, wherein the auxiliary additive is contained in an amount of 0.01 to 10 wt % based on the total weight of the non-aqueous electrolyte solution.

11. A power storage device comprising: a positive electrode; a negative electrode; and the non-aqueous electrolyte solution of claim 1.

12. The power storage device of claim 11, wherein an active material of the positive electrode includes a composite metal oxide of lithium including one or two or more selected from the group consisting of cobalt, manganese, and nickel; or a lithium-containing olivine-type phosphate containing one or two or more selected from the group consisting of iron, cobalt, nickel, and manganese.

13. The power storage device of claim 11, wherein an active material of the negative electrode includes one or two or more selected from the group consisting of a carbon material, tin, a tin compound, silicon, a silicon compound, and lithium titanate.

14. The power storage device of claim 11, wherein an active material of the negative electrode includes lithium metal.

15. The power storage device of claim 11, wherein the power storage device is a lithium secondary battery.

16. A compound represented by the following Chemical Formula 1: 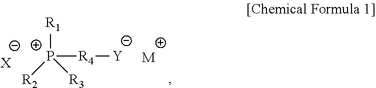
wherein in Chemical Formula 1;
R₁ to R₄, Y⁻, M⁺, and X⁻ are the same as defined in claim 1.
